(19) United States
(12) Patent Application Publication
(10) Pub. No.: US 2005/0097384 A1
(43) Pub. Date: May 5, 2005

(54) Data processing system with fabric for sharing an I/O device between logical partitions

(75) Inventors: Keitaro Uehara, Kokubunji (JP); Toshiomi Moriki, Kunitachi (JP); Yuji Tsushima, Hachioji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 10/887,889

(22) Filed: Jul. 12, 2004

(30) Foreign Application Priority Data
Oct. 20, 2003 (JP) 2003-359589

(51) Int. Cl. G06F 11/00

(52) U.S. Cl. 714/1

(57) ABSTRACT

The present invention makes coordination of I/O access operations of operating systems independently running in logical partitions. In a data processing system comprising processors, a main memory, I/O slots, and a node controller, wherein the processors, the main memory, and the I/O slots are interconnected via the node controller and divided into a plurality of partitions in which individual operating systems are run simultaneously, the node controller includes a logical partition arbitration unit which stores information as to whether each logical partition is using an I/O slot and controls access from each logical partition to an I/O slot by referring to the information thus stored.

### CROSS-REFERENCE TO RELATED APPLICATION

This application is related to a U.S. application Ser. No. 10/372,266 filed Feb. 25, 2002, entitled “Data Processing System for Keeping Isolation between Logical Partitions”, the disclosure of which is hereby incorporated by reference.

### CLAIM OF PRIORITY

The present application claims priority from Japanese application JP 2003-359589 filed on Oct. 20, 2003, the content of which is hereby incorporated by reference into this application.

### FIELD OF THE INVENTION

The present invention relates to a technique of generating a plurality of logical partitions on a computer and, more particularly, to a technique for making coordination of I/O access operations of operating systems independently running in the logical partitions.

### BACKGROUND OF THE INVENTION

With recent improvement of computer performance, there have been numerous moves to consolidate processes that were previously distributed across a plurality of servers into a single server for cost reduction. An effective means for such consolidation is a partitioning technique which allows a plurality of operating systems to be run on a single server. The partitioning technique enables smooth server migration by making a single server correspond to a single partition on a server.

To address the need for this partitioning technique, a physical portioning technique is known in which partitions are physically configured in a computer to run a plurality operating systems respectively in the partitions. As a typical physical partitioning technique, Dynamic System Domains are offered by Sun Microsystems, Inc. (for example, refer to non-patent document 1). In this physical portioning technique, computer resources such as processor performances and memory capacities that can be allocated to the partitions are only clusters of physical processors and memories (in units of nodes in most cases). In the circumstances where processor performance becomes higher and higher and memory capacity becomes larger and larger at a high pace, assigning a conventional single server function to a physical partition resulted in a surplus of the performances of processors and the capacities of memories and this was wasteful.

Thus, a logical partitioning technique draws attention which virtualizes physical processors and memories and generates an arbitrary number of logical partitions in a computer. The logical partitioning technique is realized by firmware that is called a hypervisor. In the logical partitioning technique, each operating system (guest OS) is run on a logical processor that the hypervisor provides and the hypervisor maps a plurality of logical processors to a physical processor, thus enabling partitioning in smaller units than nodes. As for the processors, a single physical processor can be shared across a plurality of logical partitions and tasks assigned to the logical partitions can be executed by the processor by time division switching. Thereby, logical partitions more than the number of physical processors can be generated and tasks assigned thereto can be simultaneously executed.

An approach using another method than the logical partitioning technique is a virtual server technique (for example, refer to non-patent document 2). In the virtual server technique, only a single host OS exists in a whole server, a guest OS is run as an application on top of the host OS, and the host OS always processes all I/O accesses.
[Non-patent document 1] Sun Microsystems, “Ultra Enterprise 10000 Dynamic System Domains Technical White Paper” [online]<URL;http://jp.sun.com/products/servers/highend/10000/pdf, <domains.pdf>
[Non-patent document 2] “VMware GSX Server” [online] February, 2001, Internet u<URL;http://www.VMware.com/products/server/gsx_features.html>

As described above, in the logical partitioning technique, a same processor can be shared across logical partitions in the time division manner. However, I/O slots or I/O devices have to be allocated to the logical partitions fixedly. Consequently, this poses a problem that the number of logical partitions to be generated by logical partitioning is limited by the number of physical I/O slots. In the case of consolidating a plurality of servers into a single server, the servers assigned to the logical partitions each need four or five kinds of I/O cards such as a device for booting, backbone network connection, device for data use, network for failover, and network for maintenance. In this case, therefore, if there are 16 physical I/O slots, only a maximum of three or four logical partitions can be generated. Accordingly, a need for sharing an I/O slot or I/O device with different logical partitions arises.

By way of the virtual server technique described in non-patent document 2, a plurality of guest OSs can share a single I/O device so that a plurality of applications on top of the OS can share the single I/O device. In this technique, however, data transferred from the I/O device to the memory space of the host OS by Direct Memory Access (DMA) must be copied to the memory space of each guest OS. In short, DMA data must be copied between the host OS and each guest OS. Therefore, this poses a problem that performance decreases, compared with performance if each OS would directly access the I/O device.

### SUMMARY OF THE INVENTION

An object of the present invention is to realize sharing an I/O slot between logical partitions by time division switching between the logical partitions to use the I/O slot without causing a decrease in performance regarded as a drawback with the virtual server technique.

In each of logical main memory spaces allocated to the logical partitions, a logical memory mapped I/O area corresponding to a physical memory mapped I/O area associated with a shared I/O slot is provided. A node controller comprises a main memory monitoring unit to monitor for access to the main memory, an I/O monitoring unit to monitor for I/O access and interruption, a logical partition arbitration unit which arbitrates between a plurality of logical partitions to exclusively use an I/O slot, and a main memory and I/O synchronization unit which performs synchronization between logical and physical memory mapped I/O areas.

When a guest OS in a logical partition is accessing the shared I/O slot, it issues a request for access to the logical memory mapped I/O area. The main memory monitoring unit monitors for a command writing to the logical memory mapped I/O area and, upon the command write occurring, notifies the logical partition arbitration unit of the write event. Unless another logical partition is using the I/O device, the logical partition arbitration unit issues a directive to the main memory and I/O synchronization unit. The main memory and I/O synchronization unit transfers the command and parameters written to the logical memory mapped I/O area to the physical memory mapped I/O area of the shared I/O slot. At this time, if necessary, a logical address included in the parameters is translated into a physical address. Alternatively, the main memory and I/O synchronization unit changes the memory mapping for the logical partition, that is, directly maps the logical memory mapped I/O area to the physical memory mapped I/O area. Then, actual I/O access starts.

The I/O monitoring unit monitors for an interrupt occurring from the I/O slot and detects an I/O access completion. Upon the completion of the I/O access, the I/O monitoring unit notifies the logical partition arbitration unit of the access completion. The logical partition arbitration unit issues a directive to the main memory and I/O synchronization unit to transfer the status and parameters from the physical memory mapped I/O area of the I/O slot to the logical memory mapped I/O area of the logical partition that was using the I/O slot. At this time, if necessary, a physical address included in the parameters is translated into a logical address. After the transfer of the parameters is completed, the main memory and I/O synchronization unit notifies the logical partition arbitration unit of the transfer completion. The logical partition arbitration unit changes the state of using the I/O slot to none that is using the I/O slot. If the memory mapping was changed, demapping is performed to inhibit the logical partition from directing accessing the physical memory mapped I/O area. The logical partition arbitration unit notifies the guest OS in the logical partition of the I/O completion interrupt.

Through the above series of operations, the I/O slot can be shared between the logical partitions.

According to the present invention, when a single server divided into a plurality of logical partitions by logical partitioning is used, a single I/O slot can be shared by a plurality of logical partitions. This avoids that the maximum number of logical partitions is limited by the number of I/O slots. Because an I/O slot can be fixedly allocated to a logical partition in the same way as in the conventional logical partitioning techniques, flexible logical partitioning design becomes possible through consideration of high independency of a partition and convenience of sharing an I/O slot.

Because data can be transferred directly between the main memory space and a device installed in an I/O slot by DMA, overhead occurring during data copy operation is smaller than the virtual server technique and communication at a higher rate can be performed.

### BRIEF DESCRIPTION OF THE DRAWINGS

FIG. 1 is a block diagram showing a computer system configuration with a contrivance of logical partitions in accordance with a first embodiment of the present invention;

FIG. 2 illustrates how hardware resources are divided into logical partitions in the computer system of the first embodiment of the invention;

FIG. 3 is a memory map representing a detailed main memory structure in the computer system of the first embodiment of the invention;

FIG. 4 illustrates an example of a logical memory mapped I/O area in the computer system of the first embodiment of the invention;

FIG. 5 is a memory map showing an example of mapping logical main memory spaces to physical main memory space on the main memory in the computer system of the first embodiment of the invention;

FIG. 6 illustrates exemplary contents of an I/O arbitration table in the computer system of the first embodiment of the invention;

FIG. 7 illustrates exemplary contents of an I/O event table in the computer system of the first embodiment of the invention;

FIG. 8 is a flowchart describing a procedure to start using an I/O slot in the computer system of the first embodiment of the invention;

FIG. 9 is a flowchart describing a procedure to finish using the I/O slot in the computer system of the first embodiment of the invention;

FIG. 10 illustrates an address translation table in a first modification example to the first embodiment of the invention;

FIG. 11 illustrates relationship of mapping between logical and physical main memory spaces and mapping between logical and physical memory mapped I/O areas in a second modification example to the first embodiment of the invention;

FIG. 12 is a flowchart of a procedure to start using an I/O slot in the second modification example to the first embodiment of the invention;

FIG. 13 is a flowchart of a procedure to finish using the I/O slot in the second modification example to the first embodiment of the invention;

FIG. 14 illustrates an example of a logical main memory space in a third modification example to the first embodiment of the invention;

FIG. 15 illustrates exemplary contents of an I/O event table in the third modification example to the first embodiment of the invention;

FIG. 16 is a flowchart of a procedure to finish using the I/O slot in the third modification example to the first embodiment of the invention;

FIG. 17 is a flowchart of a procedure to select a logical partition that will use an I/O slot in a fourth modification example to the first embodiment of the invention;

FIG. 18 illustrates data structures (queues) and a timer which are used in the fourth modification example to the first embodiment of the invention;

FIG. 19 illustrates exemplary contents of an I/O event table in a fifth modification example to the first embodiment of the invention;

FIG. 20 is a flowchart of a procedure to finish using the I/O slot in the fifth modification example to the first embodiment of the invention;

FIG. 21 is a block diagram showing an overall structure of a server with logical partitions in accordance with a second embodiment of the present invention; and

FIG. 22 illustrates an example of a screen for setting which is performed on a setup console for the server of the second embodiment of the invention.

### DETAILED DESCRIPTION OF THE PREFERRED EMBODIMENTS

Now, a computer system in accordance with a first embodiment of the present invention will first be described.

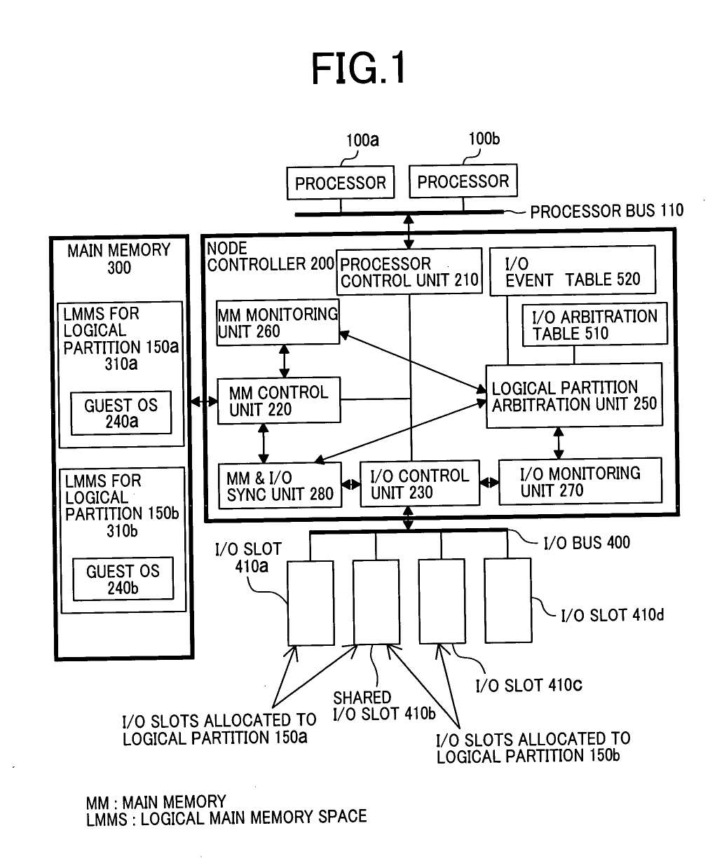

FIG. 1 is a block diagram showing a computer system configuration with a contrivance of logical partitions in accordance with the first embodiment of the present invention.

A processor bus 110, a main memory 300, and an I/O bus 400 are interconnected via a node controller 200. Although not explicitly shown in this figure, a multiple-nodes configuration in which a plurality of node controllers 200 are interconnected in a multiplex manner is also possible. The following description should be construed independent of the number of nodes.

Two processors 100a, 100b are connected to the processor bus 110. It is sufficient if one or more processors 100 are connected to the processor bus. Four I/O slots 410a-410b are connected to the I/O bus 400. It is sufficient if one or more I/O slots 410 are connected to the I/O bus. Although not shown in FIG. 1, I/O cards are respectively connected to the I/O slots 410 and one or more I/O devices are connected to each I/O card.

The node controller 200 includes a processor control unit 210 to control the processor bus 110, a main memory control unit 220 to control the main memory 300, and an I/O control unit 230 to control the I/O bus 400. The node controller 200 also includes a main memory monitoring unit 260 to monitor for access to the main memory 300, an I/O monitoring unit 270 to monitor for access and interruption to the I/O bus, a logical partition arbitration unit 250 which controls allocation of the processors, main memory, and I/O slots to logical partitions and performs arbitration when a plurality of logical partitions share an I/O slot 410, and a main memory and I/O synchronization unit 280 which performs synchronization between memory mapped I/O areas, one existing on the main memory 300 and the other associated with each I/O slot 410, and the above units are interconnected. The logical partition arbitration unit 250 has an I/O arbitration table 510 and an I/O event table 520.

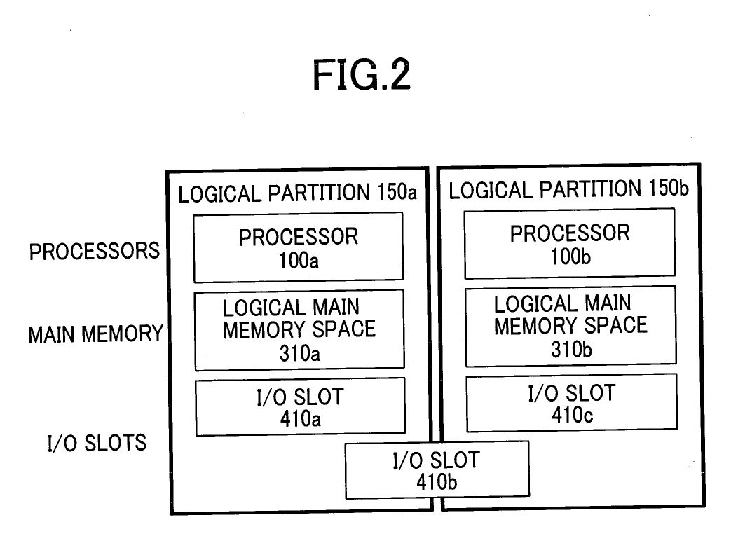

The processors 100, main memory 300, and I/O slots 410 are divided into two or more logical partitions 150. FIG. 2 illustrates how these hardware resources are divided into the partitions.

In the present embodiment, the processors 100, main memory 300, and I/O slots 410 are divided into two logical partitions 150a and 150b. The processor 100a is allocated to the logical partition 150a and the processor 100b is allocated to the logical partition 150b. Of the main memory 300, logical main memory space 310a areas are allocated to the logical partition 150a and logical main memory space 310b areas are allocated to the logical partition 150b. An operating system (guest OS) 240 resides in each logical partition 150. Thus, a guest OS 240a resides in the logical main memory space 310a for the logical partition 150a and a guest OS 240b resides in the logical main memory space 310b for the logical partition 150b, as shown in FIG. 1.

One slot 410 is allocated to both the slots 150. An I/O slot 410a is fixedly allocated to the logical partition 150a and an I/O slot 410c is fixed allocated to the logical partition 150b, as shown in FIG. 1. An I/O slot 410b is shared between the logical partitions 150a and 150b and accessible from both the partitions. An I/O slot 410d is not associated with both the logical partitions. In the following description, the I/O slot 410b that is shared between the logical partitions will be called a “shared I/O slot” 410b.

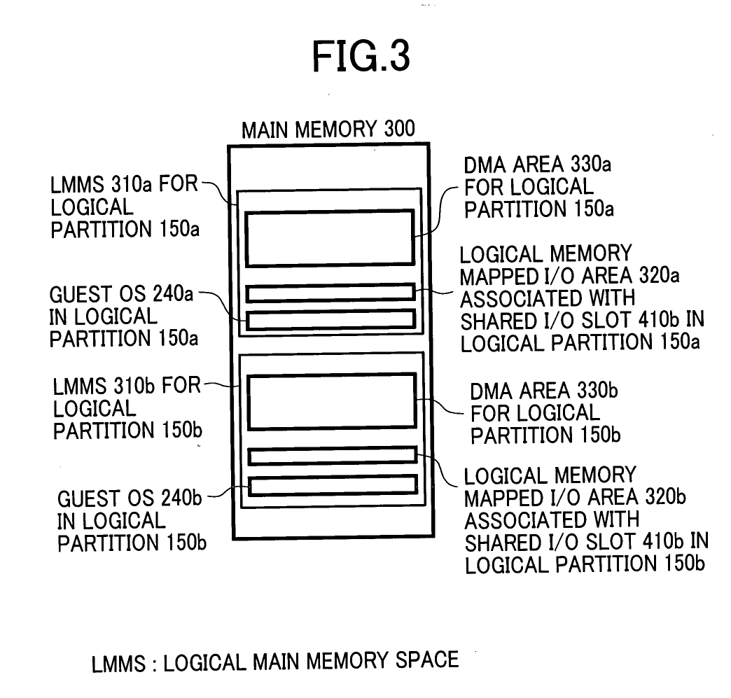

FIG. 3 is a memory map representing a detailed structure of the main memory 300.

The logical main memory space 310a allocated to the logical partition 150a further includes a DMA (Direct Memory Access) area 330a for the logical partition 150a and a logical memory mapped I/O area 320a associated with the shared I/O slot 410b in the logical partition 150a. Likewise, the logical main memory space 310b allocated to the logical partition 150b includes a DMA area 330b for the logical partition 150b and a logical memory mapped I/O area 320b associated with the shared I/O slot 410b. The logical main memory space 310a also includes an area for a guest OS 240a where an OS to run in the logical partition 150a is installed (loaded) and the logical main memory space 310b also includes an area for a guest OS 240b where an OS to run in the logical partition 150b is installed (loaded).

Although the logical main memory spaces 310 comprising sequential areas are shown, actual allocations thereof may comprise non-sequential areas.

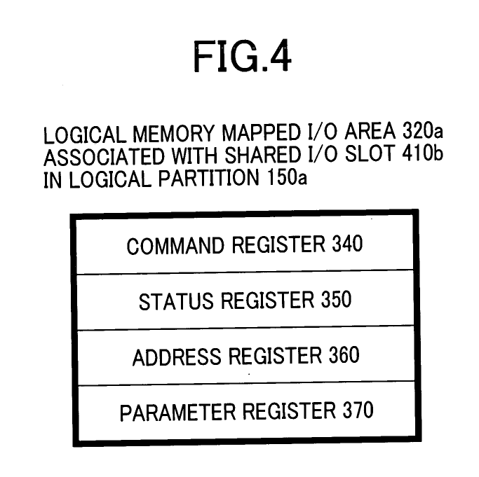

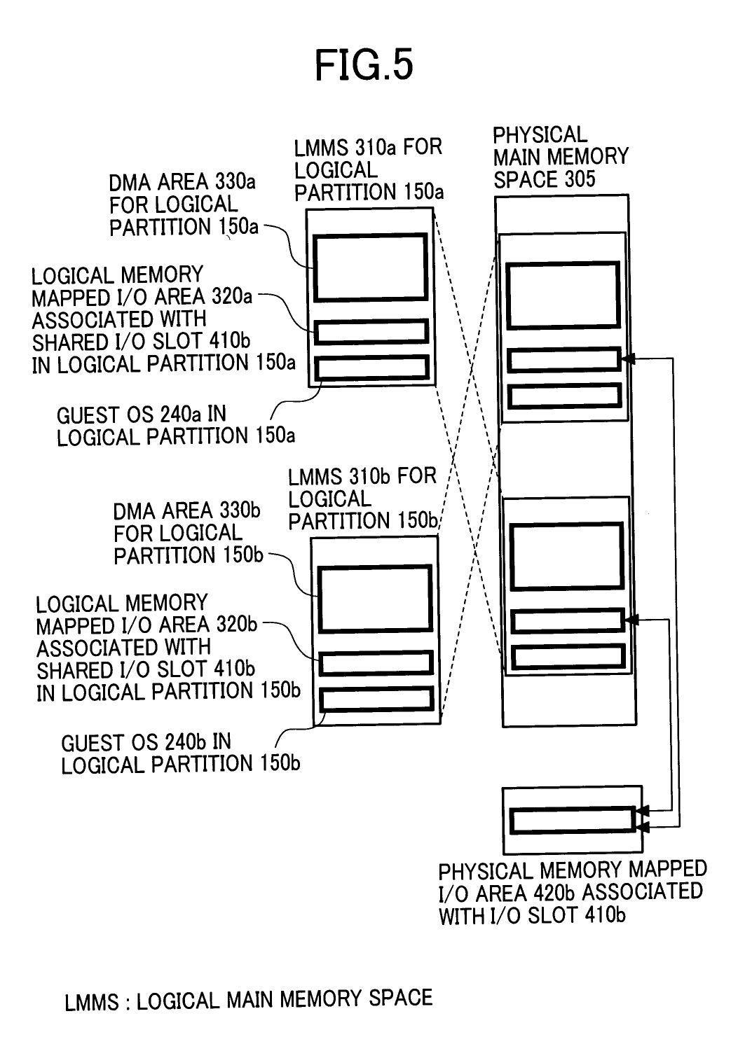

FIG. 4 illustrates an example of the above-mentioned logical memory mapped I/O area 320a in the logical main memory space 310a allocated to one of the logical partitions 150. The logical memory mapped I/O area 320a associated with an I/O slot (the shared I/O slot 410b in this instance) has the same structure as the structure of a physical memory mapped I/O area 420b associated with the I/O slot (see FIG. 5). That is, this logical memory mapped I/O area 320a comprises four registers: a command register 340 into which a specific value to cause an I/O action upon the actual I/O slot is written, a status register 350 into which the result of the I/O action is stored, an address register 360 which stores an address in the DMA area, and a parameter register 370 which stores other parameters.

FIG. 5 is a memory map showing an example of mapping the logical main memory spaces 310 to physical main memory space 305 on the main memory 300.

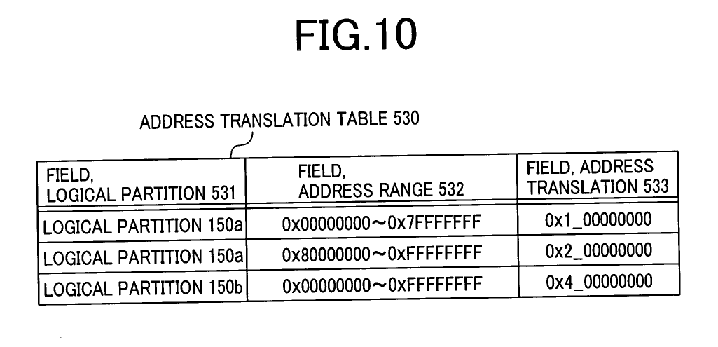

The logical main memory spaces 310 that are mapped into the physical main memory space 305 need not always comprise sequential areas, as described above. As will be explained with a first modification example (FIG. 10) which will be discussed later, the address sequence of the physical main memory space 305 need not match that of the logical main memory spaces 310. The physical memory mapped I/O area 420b exists separately from the physical main memory space 305 and provides an interface for access to the shared I/O slot 410b in conjunction with writing to or reading from the registers as described with reference to FIG. 4.

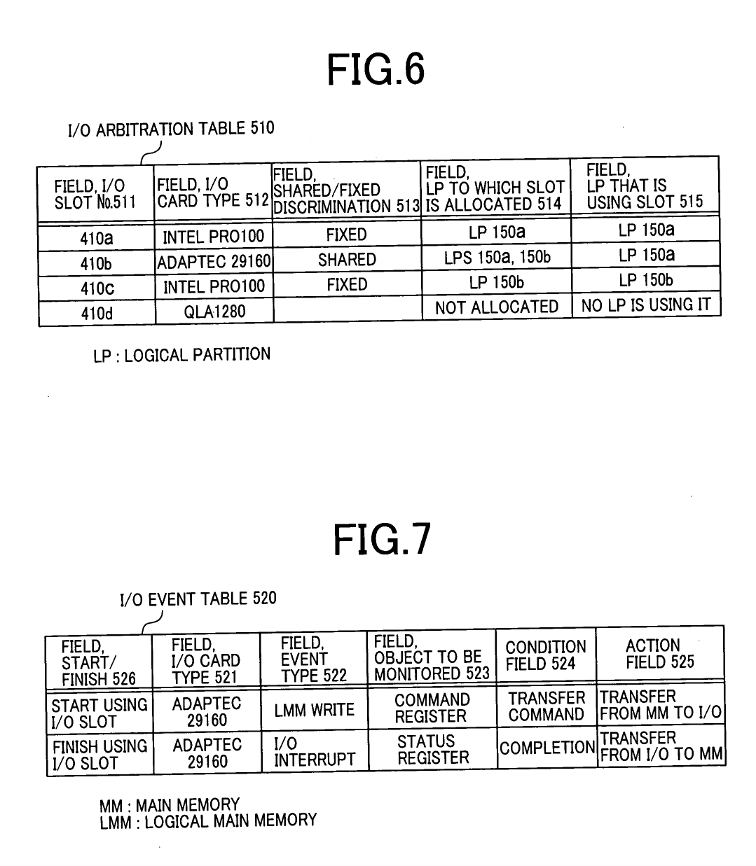

FIG. 6 illustrates exemplary contents of the I/O arbitration table 510 held by the logical partition arbitration unit 250.

The I/O arbitration table 510 is made up of column fields: I/O slot number 511; I/O card type 512; shared/fixed discrimination 513; LP (Logical Partition) to which slot is allocated 514; and LP that is using slot 515. For each row, the field, I/O slot number 511 contains an identifier assigned to an I/O slot 410. The field, I/O card type 512 contains a type designator to designate the type of the I/O card connected to the above I/O slot 410.

The field, shared/fixed discrimination 513 contains a value indicating whether the above I/O slot 410 is shared by the plurality of logical partitions 150 or fixedly allocated to only one logical partition 150. The field, LP to which slot is allocated 514 contains the identifier(s) of logical partition(s) to which the above I/O slot 410 is allocated. The field, LP that is using slot 515 contains the identifier of a logical field that is now using the above I/O slot 410.

The field, shared/fixed discrimination 513 may be updated and the field, LP to which slot is allocated 514 is updated when the I/O slot 410 is reallocated to another logical partition, but these fields are not updated during the active state of the logical partition (while the logical partition is using the allocated I/O slot). If the I/O slot is fixedly allocated to only one logical partition 150, the entries in the field, shared/fixed discrimination 513 and the field, LP to which slot is allocated 514 are invariable, remaining set to “fixed” and to the logical partition 150 to which the slot is allocated. Otherwise, if the I/O slot is shared by the plurality of logical partitions 150, the latter field entry may be changed to either of the following: “No LP is using it” and a logical partition to which the slot is allocated. Referring to the entry in the field, LP that is using slot 515 indicating the logical partition 150 that is now using the I/O slot (or no LP that is using the I/O slot), the logical partition arbitration unit 250 manages allocating the I/O slots and the logical partitions.

FIG. 7 illustrates exemplary contents of the I/O event table held by the logical partition arbitration unit 250. This table is used by the logical partition arbitration unit 250, main memory monitoring unit 260, and I/O monitoring unit 270.

The I/O event table 520 defines events to be monitored by the main memory monitoring unit 260 and I/O monitoring unit 270 and actions to be triggered by the events occurring. For each row, field, start/finish 526 contains a type indicator to indicate whether to start or finish using the I/O slot. Field, I/O card type 521 contains an I/O card type designator, as does the I/O card type 512 field in the I/O arbitration table 510. According to this I/O card type, an arrangement of the registers in the memory mapped I/O area (see FIG. 4) is determined.

Field, event type 522 contains what is to be detected as an event, such as main memory read/write, I/O read/write, or an interrupt. Field, object to be monitored 523 contains a register or port to which to write data or from which to read data. Condition field 524 contains a condition; if the result of the read or write fulfills the condition, it is judged that the event occurs. Action field 525 contains an action to be triggered by the event occurring, such as “transfer from main memory to I/O” and “transfer from I/O to main memory.”

Then, the operation of the partitioned computer system of the first embodiment of the present invention will be explained, using FIGS. 1 through 7.

Now assume that an access (I/O read) from the guest OS 240a in the logical partition 150a to the I/O slot 410b is performed.

The access to the memory mapped I/O area associated with the I/O card in the I/O slot 410b, issued by a device driver within the guest OS 240a, is executed via the main memory control unit 220 as the access to the logical memory mapped I/O area 320a in the logical main memory space 310a.

The logical memory mapped I/O area 320a comprises the command register 340, status register 350, address register 360, and parameter register 370, as shown in FIG. 4. Now take an instance where data is read from the I/O device connected to the I/O slot 410.

The device driver first sets the offset and length of the data to read on the I/O device to the parameter register 370 in the logical memory mapped I/O area 320a. Then, the device driver sets an address within the DMA area 330a to which the data to be read will be stored to the address register 360. Finally, the device driver sets a “read” command to the command register 340.

When the “read” command is written to the command register 340 in the logical memory mapped I/O area 320a by the device driver within the guest OS, entry data associated with the I/O slot 410 in the I/O event table 520 (FIG. 7) is updated. Then, the main memory monitoring unit 260 refers to the I/O event table 520 and knows that there is an event to start using the I/O slot. As possible methods in which the main memory monitoring unit 260 finds what command has been written to the command register 340, instead of referring to the I/O event table 520, the following are conceivable: trapping an access by way of access control of accessible pages; and comparing the addresses specified in transactions that are issued from a processor and detecting a command.

Next, the main memory monitoring unit 260 notifies the logical partition arbitration unit 250 that the logical partition 150a is going to start using the I/O slot 410b. Upon receiving this notification, the logical partition arbitration unit 250 refers to the field, LP that is using slot 515 for the I/O slot 410b in the I/O arbitration table 510. If the entry in this field is “No LP is using it,” the logical partition arbitration unit 250 changes it to “logical partition 150a” as information indicating the logical partition that is to start using the I/O slot and issues a directive (transfer from main memory to I/O at this point of time) to the main memory and I/O synchronization unit 280, according to the entry in the action field 525 in the I/O event table 520.

Upon receiving this directive from the logical partition arbitration unit 250, the main memory and I/O synchronization unit 280 transfers the values (parameters) written into the logical memory mapped I/O area 320a to the I/O port for the I/O slot 410b. Thereby, an I/O read is activated in the I/O slot 410 and data is read from the specified location on the I/O device and transferred to the DMA area 330a. Upon the completion of the data transfer to the DMA area 330a, an “I/O completion” interrupt occurs from the I/O slot 410b.

The I/O monitoring unit 270 monitors for an I/O interrupt, referring to the I/O event table 520. Upon detecting the interrupt, the I/O monitoring unit 270 reads the status register for the I/O slot 410b. If the status register value indicates “completion,” the I/O monitoring unit 270 notifies the logical partition arbitration unit 250 that the logical partition 150a has finished using the I/O slot 410b.

Upon receiving the notification from the I/O monitoring unit 270, the logical partition arbitration unit 250 refers to the I/O arbitration table 510. Knowing that the logical partition 150a has finished using the I/O slot 410b, the logical partition arbitration unit 250 issues a directive (transfer from I/O to main memory at this point of time) to the main memory and I/O synchronization unit 280, according to the entry in the action field 525 for the case of finishing using the I/O slot in the I/O event table 520.

Upon receiving this directive from the logical partition arbitration unit 250, the main memory and I/O synchronization unit 280 transfers the corresponding register values in the memory mapped I/O area of the I/O slot 410b to the logical main memory space 310a. After the completion of the transfer, the main memory and I/O synchronization unit 280 notifies the logical partition arbitration unit 250 of the transfer completion.

The logical partition arbitration unit 250 changes the entry in the field, LP that is using slot 515 for the I/O slot 410b to “No LP is using it” in the I/O arbitration table 510. The logical partition arbitration unit 250 generates an I/O access completion interrupt and sends the I/O access completion interrupt to the guest OS in the logical partition 150a.

Through the above series of operations, the logical partition 150a can use the shared I/O slot 410b.

When the logical partition arbitration unit 250 is notified that the logical partition 150a is going to start using the I/O slot 410b, if the I/O slot 410b is already used by the other logical partition 150b, the request for I/O access to that slot from the guest OS within the logical partition 150a is enqueued (as a pending request) within the logical partition arbitration unit 250 (in a queue that the logical partition arbitration unit 250 has). When the logical partition 150 finishes using that slot, a procedure for the logical partition 150a to start using that slot begins. Exclusive control is thus performed by the logical partition arbitration unit 250 so that the I/O slot can be shared.

Next, the procedures to start and finish using the I/O slot in the partitioned computer system of the first embodiment of the present invention will be explained.

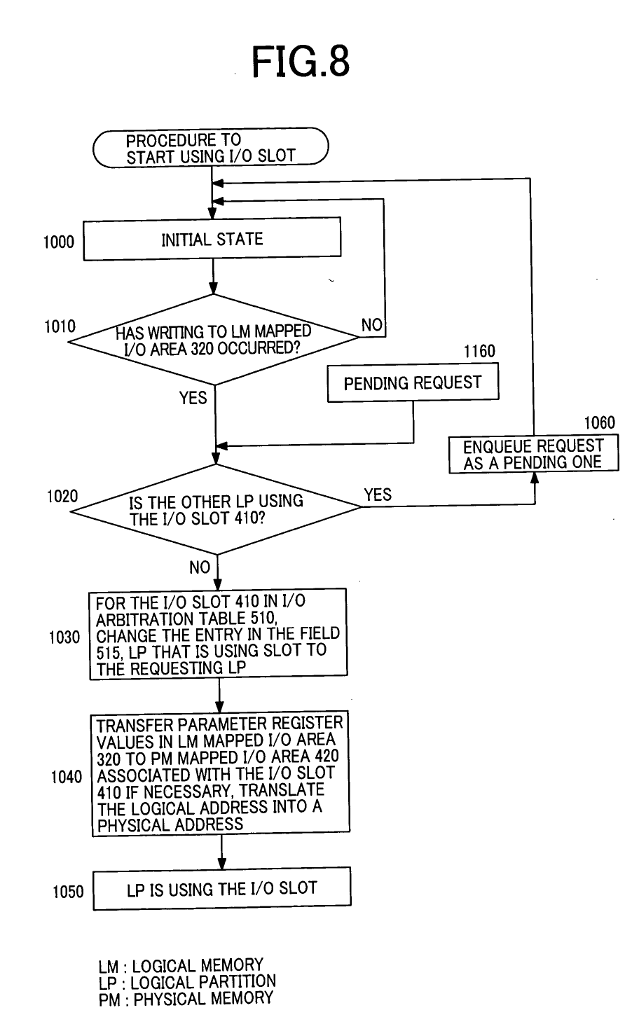

FIG. 8 is a flowchart describing the procedure for a logical partition to start using the I/O slot.

The procedure starts with step 1000 in the initial state.

The logical partition arbitration unit 250 monitors whether writing to the logical memory mapped I/O area 320 has occurred (step 1010). If the writing has occurred, the procedure goes to step 1020; if not, the procedure returns to step 1000.

In step 1020, it is checked whether the other logical partition is using the I/O slot 410 by referring to the field, LP that is using slot 515 in the I/O arbitration table 510. If the other logical partition is specified in the field, LP that is using slot 515, the procedure goes to step 1060. If not, the procedure goes to step 1030.

In step 1060, the request is enqueued as a pending one and the procedure returns to step 1000.

In step 1030, for the I/O slot 410 in the I/O arbitration table 510, by changing the entry in the field, LP that is using slot 515 to the requesting logical partition, the I/O arbitration table is updated, and the procedure goes to step 1040.

In step 1040, the main memory and I/O synchronization unit 280 transfers the parameter values from the logical memory mapped I/O area 320 to the physical memory mapped I/O area 420 associated with the I/O slot. At this time, if necessary, a logical address included in the parameter values is translated into a physical address. When the transfer is completed, the procedure goes to step 1050.

In step 1050, the requesting logical partition is using the I/O slot.

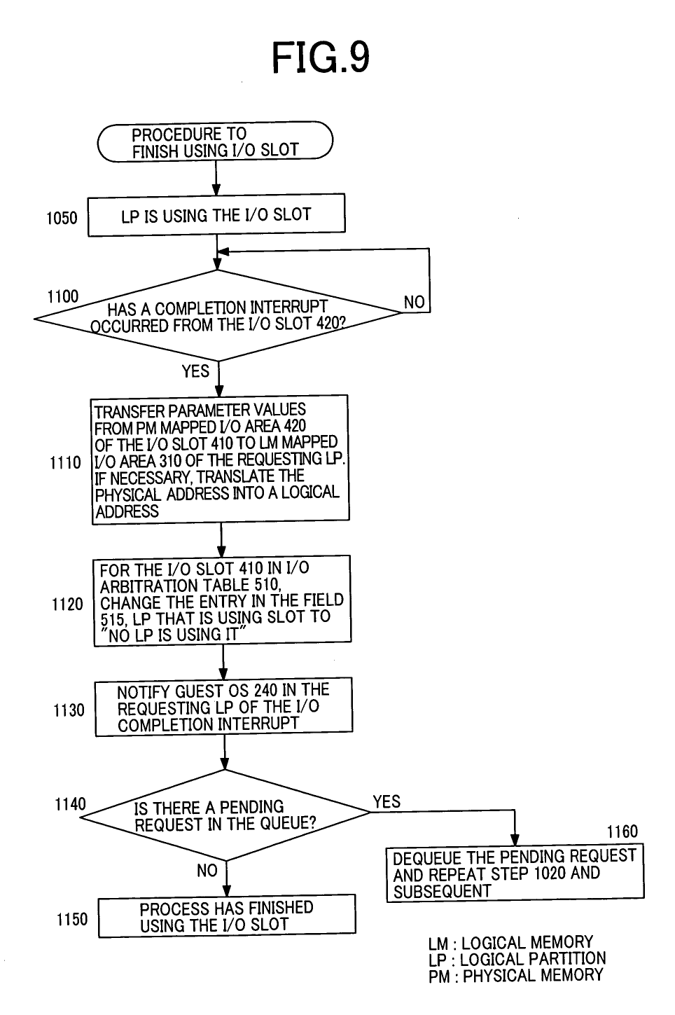

FIG. 9 is a flowchart describing the procedure for the logical partition to finish using the I/O slot.

First, the I/O monitoring unit 270 detects whether an I/O completion interrupt has occurred from the I/O slot that the logical partition is using 1050 (step 1100). If the I/O interrupt has occurred, the procedure goes to step 1110. If not, step 1100 is repeated while the logical partition continues using the I/O slot.

In step 1110, the main memory and I/O synchronization unit 280 transfers the parameter values from the physical memory mapped I/O area of the I/O slot 410 being used to the logical memory mapped I/O area 320 of the requesting logical partition. At this time, if necessary, a physical address included in the parameter values is translated into a logical address. Then, the procedure goes to step 1120.

In step 1120, the logical partition arbitration unit 250 updates the entry in the field, LP that is using slot 515 for the I/O slot 410 to “No LP is using it” in the I/O arbitration table 510 and the procedure goes to step 1130.

In step 1130, a notification of the I/O completion interrupt is sent to the guest OS in the requesting logical partition and the procedure goes to step 1140.

In step 1140, it is checked whether there is a pending request in the queue. If there is no pending request, the procedure goes to step 1150. If there is a pending request, the procedure goes to step 1160.

In step 1150, no logical partition is using the I/O slot, as the process has finished using the I/O slot. Then, the procedure returns to step 1000 (FIG. 8).

In step 1160, the pending request is dequeued and the procedure returns to step 1020 (FIG. 8).

The node controller 200 executes the above procedures described in FIGS. 8 and 9 and, thereby, requests for access to the I/O slot from the plurality of logical partitions are exclusively controlled so that the I/O slot can be shared.

Next, a first modification example to the first embodiment will be described.

The first modification example is a case where the physical addressing of the logical main memory space 310a on the main memory 300 differs from the logical addressing used by the guest OS.

In this case, the guest OS sets a logical address in the DMA area 330a to the address register in the logical memory mapped I/O area 320a and this logical address must be translated into a physical address. Logical to physical address translation is performed by referring to an address translation table 530 (FIG. 10) that is held within the main memory and I/O synchronization unit 280.

When the main memory and I/O synchronization unit 280 transfers the register values from the logical memory mapped I/O area 320 to the physical memory mapped I/O area 420 of the I/O slot 410, it makes the above translation of an address read from the address register 360, using the address translation table 530. The address is incremented or decremented by the value given in the field, address translation 533 associated with the field, address range 532 within which the address falls.

When the parameter values are transferred from the I/O slot 410 to the logical memory mapped I/O area 320, reverse address translation is performed.

In the first modification example to the first embodiment, by way of address translation using the address translation table 530 as described above, data transfer is performed the same as in the first embodiment, even if the physical addressing on the logical main memory differs from the logical addressing on the logical main memory space.

Next, a second modification example to the first embodiment will be described.

The second modification example is an instance where, when the logical partition 150a is using the shared I/O slot, the logical memory mapped I/O area 320a on the main memory 300 is directly mapped to the physical memory mapped I/O area 420a.

In the same procedure as in the first embodiment, by the detection of writing to the memory mapped I/O area 320a, the node controller works to allow the logical partition 150a to start using the shared I/O slot. At this time, the main memory and I/O synchronization unit 280 transfers the parameter values from the logical memory mapped I/O area 320a to the physical memory mapped I/O area 420b. Besides, the main memory and I/O synchronization unit 280 changes the mapping of the logical memory mapped I/O area 320a, that is, directly maps this area to the physical memory mapped I/O area 420b.

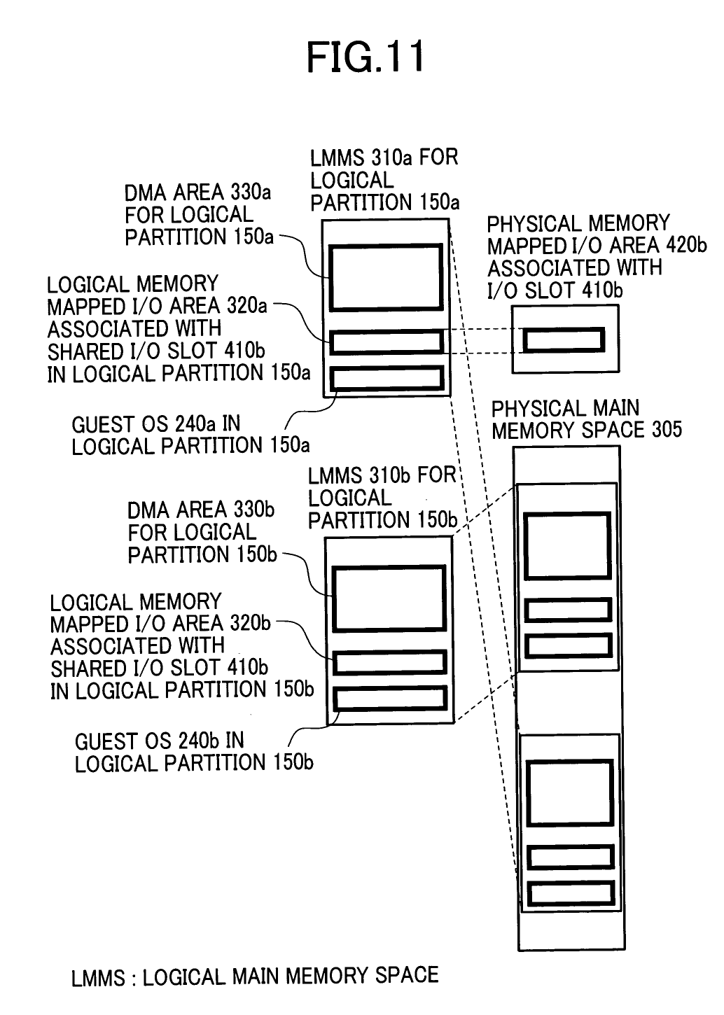

FIG. 11 illustrates this relationship of mapping between the logical main memory space 310a and the physical main memory space 305 and mapping between the logical memory mapped I/O area 320a and the physical memory mapped I/O area 420b. By this mapping, for the I/O slot 410, direct mapping between the physical memory mapped I/O area 420b and logical memory mapped I/O area 320a is performed. Thus, the guest OS 240a in the logical partition 150a can directly actuate the shared I/O slot 410b (for example, for data writing and reading) through the physical memory mapped I/O area 420b.

On the other hand, for the logical partition 150b that is not using the shared I/O slot, its logical memory mapped I/O area 320b is mapped to an area in the physical main memory space 305 and it cannot directly actuate the I/O slot 410b.

Then, upon the detection of an I/O completion interrupt from the shared I/O slot 410b, the main memory and I/O synchronization unit 280 changes the mapping of the logical memory mapped I/O area 320a, that is, demaps this area from the physical memory mapped I/O area 420b and maps it to an area in the physical main memory space 305. After this mapping, the logical partition 150a becomes unable to directly actuate the I/O slot 410b. Then, the main memory and I/O synchronization unit 280 transfers the parameter values from the physical memory mapped I/O area 420b to the logical memory mapped I/O area 320a. After this transfer, it becomes possible for the logical partition 150a to access the shared I/O slot 410b.

Similarly, when the logical partition 150b is starting using the shared I/O slot 410b, the main memory and I/O synchronization unit directly maps the logical memory mapped I/O area 320b to the physical memory mapped I/O area 420b.

Next, logical memory mapped I/O area mapping/demapping procedures in the second modification example to the first embodiment will be explained.

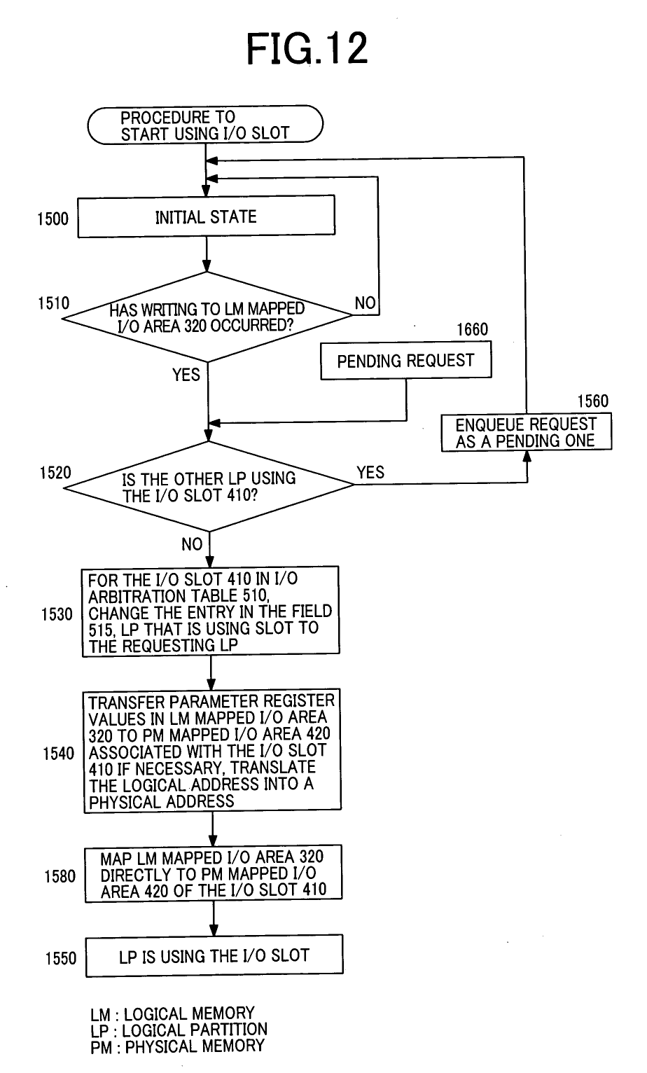

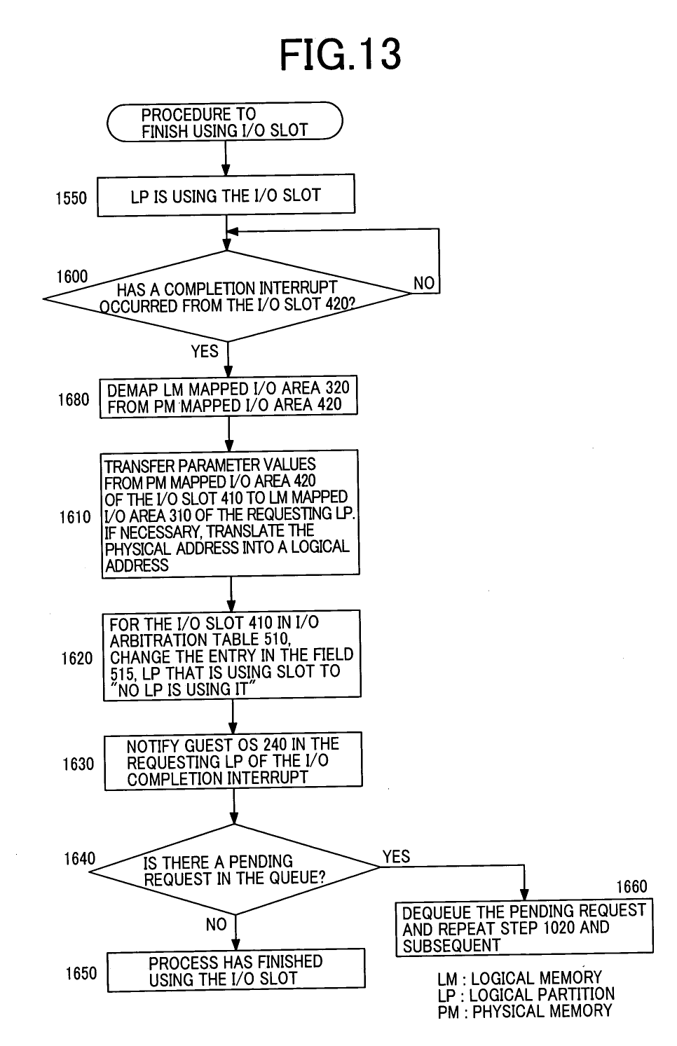

FIG. 12 is a flowchart of the procedure to start using an I/O slot in the second modification example. FIG. 13 is a flowchart of the procedure to finish using the I/O slot in the second modification example.

FIG. 12 corresponds to FIG. 8 for the first embodiment and steps 1500, 1510, 1520, 1530, 1550, and 1560 correspond to steps 1000, 1010, 1020, 1030, 1050, and 1060, respectively. Therefore, detailed explanation thereof is not repeated.

In step 1540, the same as step 1040, the parameter values are transferred from the logical memory mapped I/O area to physical memory mapped I/O area. At this time, if necessary, logical to physical address translation is performed. Then, the procedure goes to step 1580.

In step 1580, the main memory and I/O synchronization unit 280 directly maps the logical memory mapped I/O area for the requesting logical partition to the physical memory mapped I/O area. After this mapping, the logical partition becomes able to directly use the I/O slot. Then, the procedure goes to step 1550.

FIG. 13 corresponds to FIG. 9 for the first embodiment and steps 1610, 1620, 1630, 1640, 1650, and 1660 correspond to steps 1110, 1120, 1130, 1140, 1150, and 1160, respectively. Therefore, detailed explanation thereof is not repeated.

In step 1600, the same as step 1100, it is detected whether a completion interrupt has occurred from the I/O slot. If the I/O completion interrupt has occurred, the procedure goes to step 1680.

In step 1680, the main memory and I/O synchronization unit 280 demaps the logical memory mapped I/O area from the physical memory mapped I/O area. This makes the logical partition unable to directly use the I/O slot subsequently. Then, the procedure goes to step 1610.

Through these procedures of FIG. 12 and FIG. 13, switching between the logical partitions is performed so that either can directly actuate the I/O slot and, thus, the I/O slot can be shared by the plurality of logical partitions.

As described above, in the second modification example to the first embodiment, mapping change of the logical main memory spaces makes switching between logical partitions to use the I/O slot and makes it possible to share the I/O slot in a time division manner.

Next, a third modification example to the first embodiment will be described.

The third modification example is an instance of using a type of I/O card, access to which is performed via command blocks on the main memory without reading and writing parameters directly from/to the memory mapped I/O area (the registers in that area).

For recent I/O cards such as, for example, “ASC29460,” an Adaptec SCSI card (Adaptec is a registered trademark of Adaptec, Inc., the same will apply hereinafter), one or more command blocks provided on the main memory is used for access to order to enhance throughput, instead of writing parameters directly to the memory mapped I/O area. By using the command blocks, the delay of access to I/O, which is generally slower than access to the main memory, can be minimized. By using a plurality of blocks, a plurality of commands can be issued simultaneously.

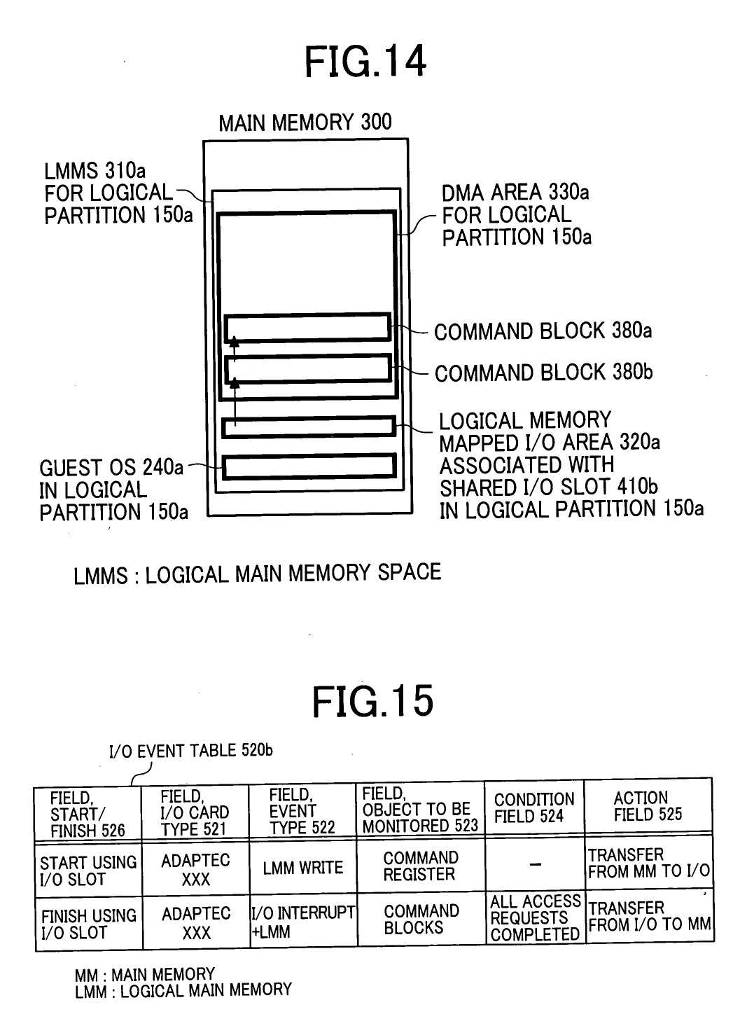

FIG. 14 illustrates an example of the logical main memory space 310a in the case where the I/O card that is accessed by using command blocks is used.

In the logical main memory space 310a, two command blocks 380a, 380b exist. It is sufficient if one or more command bocks 380 exist. Each command block has parameters such as command type, DMA address, status information, read offset, and length in the same way as stored on the registers in the memory mapped I/O area. The guest OS in one logical partition 150a sets the parameters in a command block 380. If the OS issues a plurality of commands simultaneously, it sets the parameters in both the plurality of command blocks 380a and 380b. The plurality of command blocks 380 form a list concatenated by an array or pointers.

Then, when an I/O access is actually initiated, the address of the first command bock 380a is written into the address register 360 in the logical memory mapped I/Q area 320a. In this case, the address register may also take the role of the command register 340.

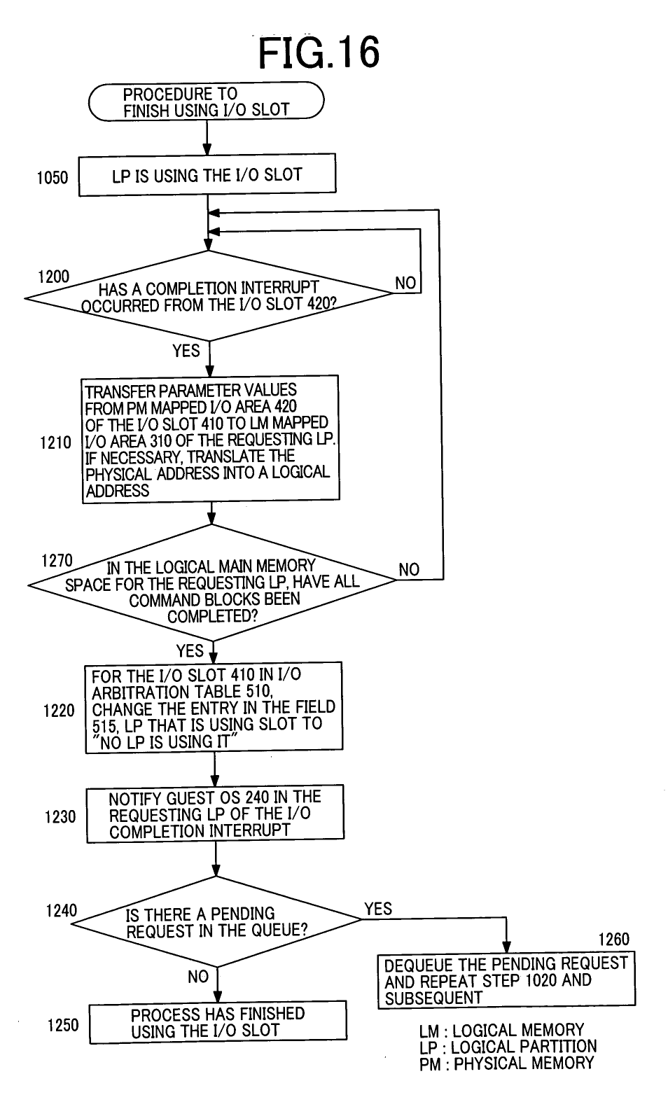

FIG. 15 illustrates exemplary contents of an I/O event table 520b in the case where the I/O card that is accessed by using command blocks is used. The contents of this table differ from those exemplified in the first embodiment in the following items. The field, object to be monitored 523 for the case of starting using I/O slot contains “address register.” The field, event type 522 for the case of finishing using I/O slot contains logical main memory in addition to I/O interrupt, which means that it must be made sure that all access requests have been completed by tracing the counters or links of the command blocks on the logical main memory. The condition by which it is judged that the completion event occurs differs, but the action to be triggered by the event occurring is the same as the case of the first embodiment.

Next, the procedures to start and finish using the I/O card of the type that is accessed by using the command blocks in the third modification example to the first embodiment will be explained.

Because the procedure to start using the I/O card is the same as the procedure described in FIG. 8, its explanation is not repeated.

FIG. 16 is a flowchart describing the procedure to finish using the I/O card. FIG. 16 corresponds to FIG. 9 for the first embodiment and steps 1200, 1220, 1230, 1240, 1250, and 1260 correspond to steps 1100, 1120, 1130, 1140, 1150, and 1160, respectively. Therefore, detailed explanation thereof is not repeated.

After the transfer of the parameter values in step 1210, the procedure goes to step 1270.

In step 1270, the command blocks 380 on the logical main storage space for the requesting logical partition are referred to and it is checked whether all the command blocks are completed. If all the command blocks 380 are completed, the procedure goes to step 1220. If not, the procedure returns to step 1050.

As described above, in the first modification example to the first embodiment, even in the case where the I/O card type that is accessed by using command blocks is used, the I/O card can be accessed by the plurality of logical partitions in the same way as in the first embodiment.

Next, a fourth modification example to the first embodiment will be described.

The fourth modification example is an instance where time division switching between the logical partitions to use the shared I/O slot is performed.

In the above-described first embodiment or the third modification example, once one logical partition 150a has started using the shared I/O slot 410b, the other logical partition 150b cannot use the I/O slot 410b until the completion of the I/O access. However, in the fourth modification example, forcible switching between the logical partitions to use the shared I/O slot is performed at given intervals by way of timer interruption or the like.

In this case, when the logical partition 150a is using the I/O slot and switching to the other logical partition 150b occurs, an I/O request interrupt may remain incomplete. For such I/O request, I/O monitoring unit 270 catches it and enqueues it as a pending one into the queue of the logical partition arbitration unit 250. When the logical partition 150a starts using the I/O slot 410 again, the pending interrupt that remains incomplete in the queue is delivered to the guest OS 240a so that the I/O access is completed.

Switching between the logical partitions by timer interruption can also be used to detect timeout in case a failure should occur in an I/O device.

Next, a procedure for time division switching between the logical partitions to use the shared I/O slot in the fourth modification example to the first embodiment.

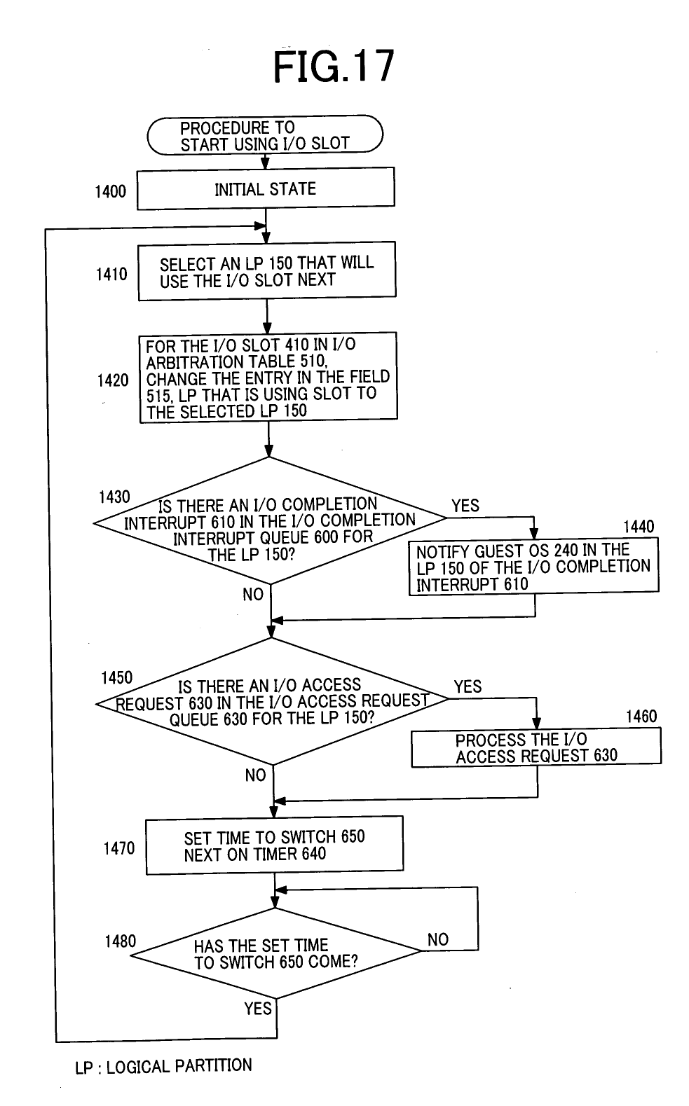

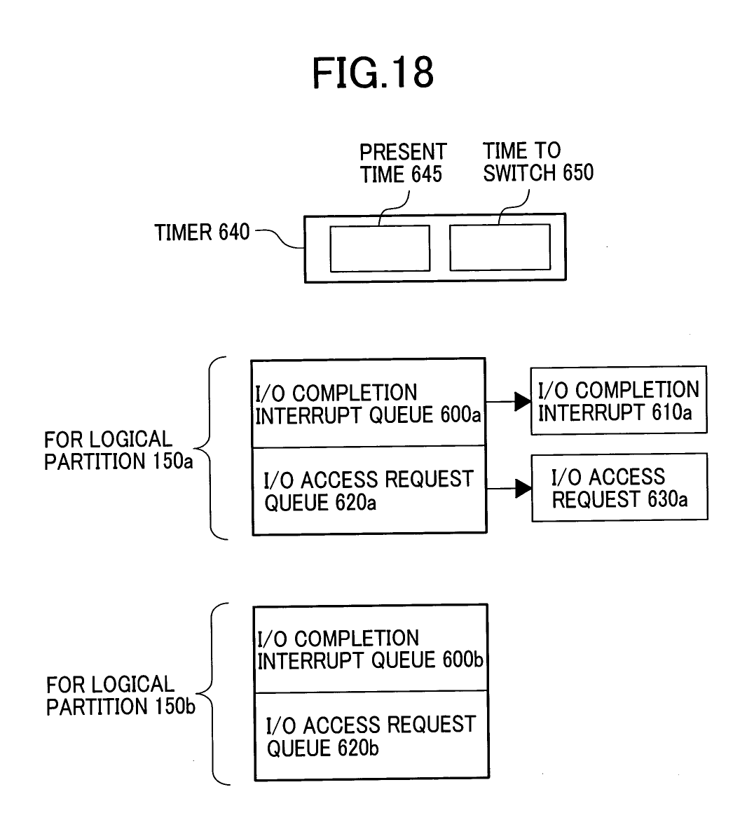

FIG. 17 is a flowchart of a procedure to select a logical partition that will use the I/O slot, which is performed by the logical partition arbitration unit 250. FIG. 18 illustrates data structures (queues) and a timer mechanism which are used in the fourth modification example.

The procedure will be explained below, according to FIGS. 17 and 18 and referring to FIGS. 1 through 7, if necessary.

Step 1400 is the initial state.

In step 1410, one logical partition 150 that will use the shared I/O slot 410b is selected. It is preferable to make this selection normally by round robin or the like so that a particular logical partition does not become low performing (so that time is evenly allocated to the logical partitions). Then, the procedure goes to step 1420.

In step 1420, the entry in the field, LP that is using slot 515 in the I/O arbitration table 510 is changed to the selected logical partition 150 and the I/O arbitration table 510 is thus updated. Then, the procedure goes to step 1430.

In step 1430, it is checked whether there is an I/O completion interrupt 610 in an I/O completion interrupt queue 600 for the selected logical partition 150. If there is no I/O completion interrupt 610, the procedure goes to step 1450; if there is an I/O completion interrupt 610, the procedure goes to step 1440.

In step 1440, the I/O completion interrupt 610 is dequeued from the I/O completion interrupt queue 600 and delivered to the guest OS 240 in the logical partition 150. Then, the procedure goes to step 1450.

In step 1450, it is checked whether there is an I/O access request 630 in an I/O access request queue 620 for the selected logical partition 150. If there is no I/O access request 630, the procedure goes to step 1470; if there is an I/O access request 630, the procedure goes to step 1460.

In step 1460, the I/O access request 630 is dequeued from the I/O access request queue 620 and delivered to the shared I/O slot 410b. Then, the procedure goes to step 1470.

In step 1470, time to switch 650 next is set on a timer 640. It is preferable to add an allocated time slice (for example, 10 ms) to the present time in order to set the time to switch. Then, the procedure goes to step 1480.

In step 1480, it is checked whether the set time to switch 650 on the timer 640 has come. It is preferable to use timer interruption in order to avoid polling. If the time to switch 650 has come, the procedure returns to step 1410 to switch to the other logical partition 150.

Access to the I/O slot 410b from the guest OS 240 is processed the same as in the first modification example to the first embodiment. However, if the entry in the field, LP that is using slot 515 in the I/O arbitration table 510 is not the requesting logical partition, the logical partition arbitration unit 250 enqueues the I/O access request as a pending one into the I/O access request queue 620. Upon the detection of an I/O completion interrupt, if the above entry is not the requesting logical partition, the logical partition arbitration unit 250 enqueues the I/O completion interrupt as a pending one into the I/O completion interrupt queue 600.

Next, a fifth modification example to the first embodiment will be described.

The fifth modification example is an instance of using a type of I/O card for which the completion of an I/O access is awaited and known by polling the status register without using an I/O completion interrupt for the I/O access.

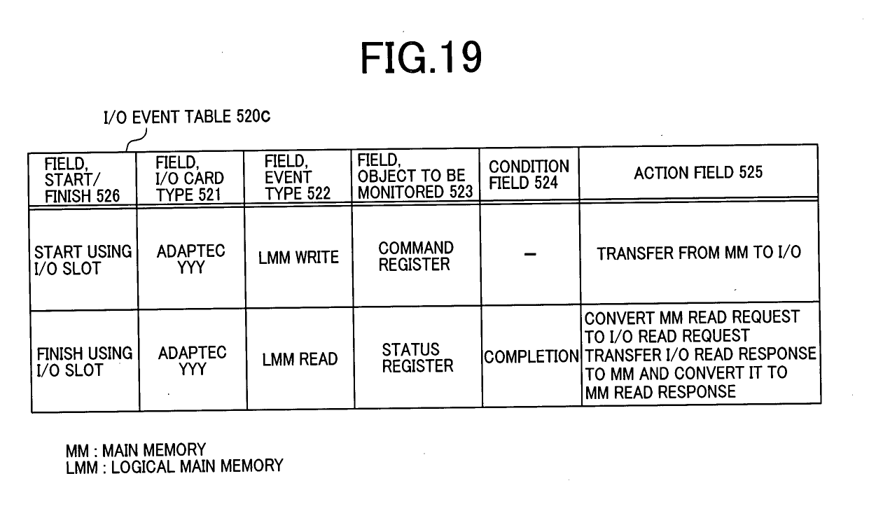

Polling operation in the fifth modification example will be explained, using FIGS. 1 through 4 and 19. FIG. 19 illustrates exemplary contents of an I/O event table 520c in the case where the polling is performed.

The guest OS in the logical partition 150a issues a request for I/O access to the shared I/O slot 410b and the logical partition 150a starts using the shared I/O slot 410b. After that, by periodically reading the status register associated with the shared I/O slot 410b, it is judged whether the logical partition 150a has finished using the shared I/O slot 410b.

Reading the status register is executed by a read request to the status register 350 in the logical memory mapped I/O area 320a. The main memory monitoring unit 260 monitors for a read request to the status register 350 and notifies the logical partition arbitration unit 250 of the read request. The logical partition arbitration unit 250 issues a directive to the main memory and I/O synchronization unit 280 to convert the read request to the logical memory mapped I/O area 320a to an I/O read request to the I/O slot 410b. The I/O monitoring unit 270 monitors for a response to the I/O read request to the I/O slot 410b and notifies the logical partition arbitration unit 250 of the I/O read response. The logical partition arbitration unit 250 issues a directive to the main memory and I/O synchronization unit 280 to convert the I/O read response to a response to the initial read request to the logical memory mapped I/O area 320a and return the response. At this time, if a value representing completion is read from the status register, it means that the logical partition has finished using the shared I/O slot.

The I/O event table contents other than the event to be monitored and the action to be triggered by the event occurring are the same as for the primary example of the first embodiment.

Next, the procedures to start and finish the I/O card for which the completion of access is detected by polling in the fifth modification example to the first embodiment will be explained.

Because the procedure to start using the I/O card is the same as the procedure described in FIG. 8, its explanation is not repeated.

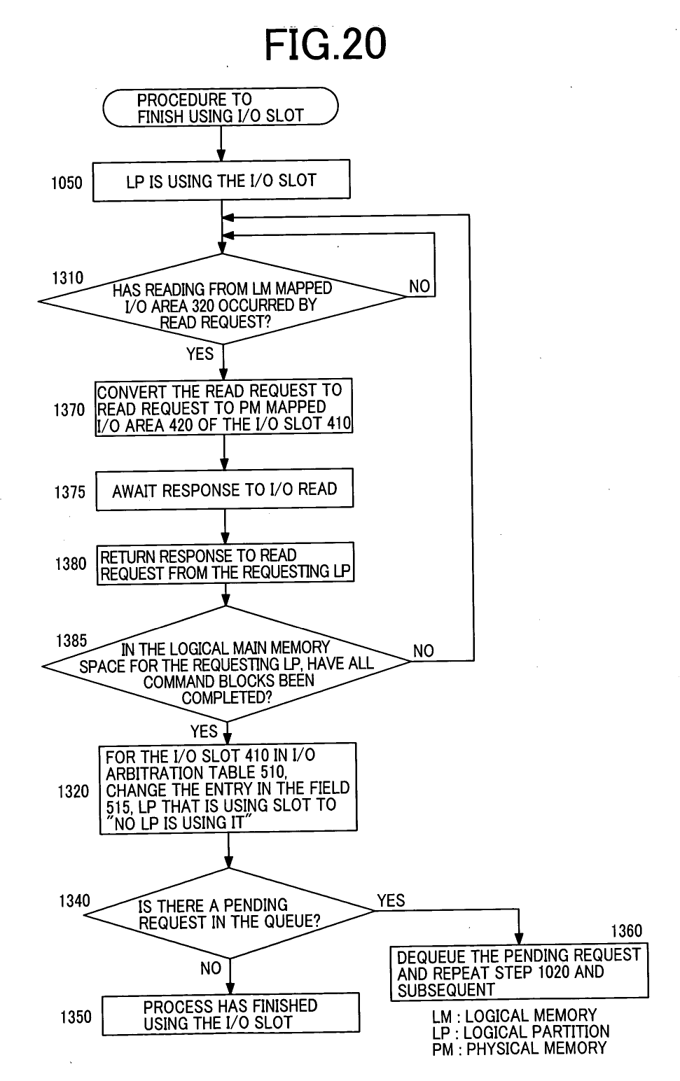

FIG. 20 is a flowchart describing the procedure to finish using the I/O card in the case of using the polling.

From the initial state 1050, the procedure first goes to step 1310.

In step 1310, the main memory monitoring unit 260 checks whether reading from the logical memory mapped I/O area 320 has occurred by a read request. If reading has not occurred, the procedure returns to step 1050. If reading has occurred, the procedure goes to step 1370.

In step 1370, the read request to the logical memory mapped I/O area is converted to a read request to the memory mapped I/O area of the I/O slot and the I/O read request is issued. The procedure goes to step 1375.

In step 1375, a response to the I/O read request issued in step 1370 is awaited. When the response has come, the procedure goes to step 1380.

In step 1380, the I/O read response is converted to the response to the read request for reading from the logical memory mapped I/O area 320, which was performed in step 1310, and the response is returned. The procedure goes to step 1385.

In step 1385, it is judged whether the returned response indicates I/O completion. If the response does not indicate the completion, the procedure returns to step 1050. In this case, the guest OS in the requesting logical partition restarts, but the I/O card still remains being used. If the response indicates the completion, the procedure goes to step 1320.

In step 1320, the logical partition arbitration unit 250 changes the entry in the field, LP that is using slot 515 for the I/O slot to “No LP is using it” in the I/O arbitration table 510 and the procedure goes to step 1340.

Because steps 1340, 1350, and 1360 correspond to steps 1140, 1150, and 1160 in FIG. 9 for the first embodiment, detailed explanation thereof is not repeated.

Next, a second embodiment of the present invention will be described.

The second embodiment concerns shared I/O slot setup and transactions on the processor bus and I/O bus.

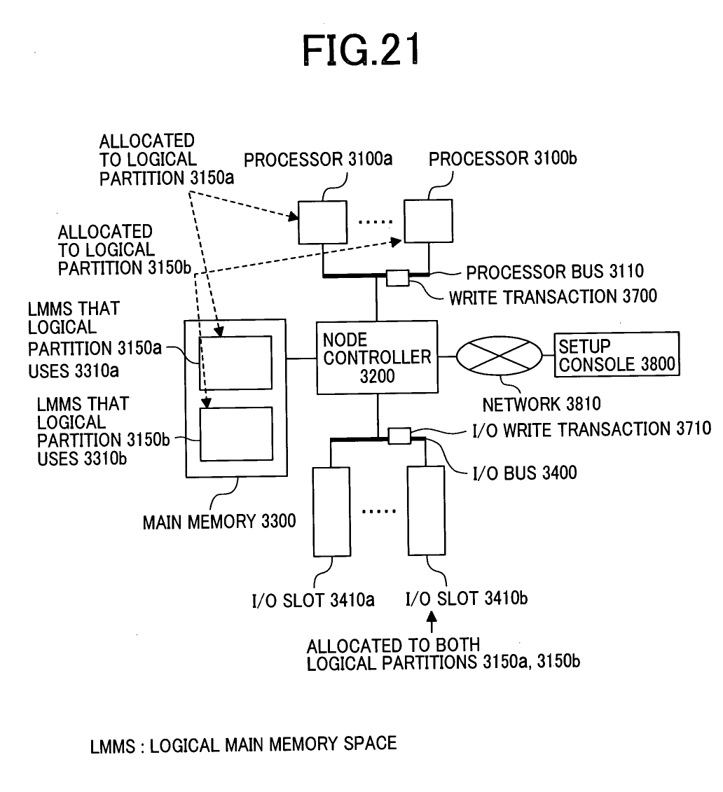

FIG. 21 is a block diagram showing an overall structure of a server with logical partitions.

A processor bus 3110, one or more main memories 3300, and an I/O bus 3400 are interconnected via a node controller 3200. The node controller 320 has the same configuration as the node controller 200 of the above compute system of first embodiment.

One or more processors 3100 are connected to the processor bus 3110. One or more I/O slots 3410 are connected to the I/O bus 3400.

The node controller 3200 is connected t a setup console 3800 via a network 3810. The network 3810 may be either a LAN or a link like a serial cable.

The setup console 3800 is a terminal device for configuring allocations of hardware resources to logical partitions.

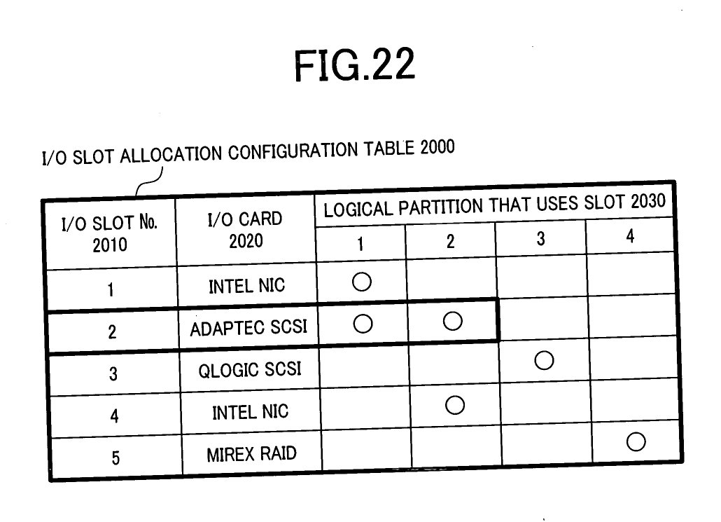

FIG. 22 illustrates an example of a screen for setting which is performed on the setup console 3800.

An I/O slot allocation configuration table 2000 is made up of column fields: I/O slot number 2010, I/O card, 2020, and logical partition that uses slot 2030. The field, logical partition that uses slot has subfields indicating what logical partition uses what I/O card. What logical partition uses what I/O card can be specified.

In the screen display example shown in FIG. 22, four logical partitions and five I/O slots are present. As is shown, logical partition 1 uses I/O slots 1 and 2, logical partition 2 uses I/O slots 2 and 4, logical partition 3 uses I/O slot 3, and logical partition 4 uses I/O slot 5. The I/O slot 2 and its I/O card are allocated to both the logical partitions 1 and 2. This indicates that a means for allocating one I/O slot to a plurality of logical partitions is provided by the setup console 3800.

Returning to FIG. 21, two logical partitions 3150a and 3150b exist in the main memory 3300. A processor 3100a is allocated to the logical partition 3150a and a processor 3100b is allocated to the logical partition 3150b. On the main memory 3300, a logical main memory space 3310a allocated to the logical partition 3150a and a logical main memory space 3310b allocated to the logical partitions 3150b exist. An I/O slot 3410b is allocated to both the logical partition 3150a and logical partition 3150b.

By a write request from the processor 3100a allocated to the logical partition 3150a, writing to the memory mapped I/O area of the I/O slot 3140b is performed. This writing related information is entered into the I/O event table in the node controller 3200, as described in the first embodiment. By referring to the event type field of the I/O event table, the main storage control unit of the node controller 3200 can detect the writing as an event to start using the I/O slot. Also, the writing is observed as a write transaction 3700 on the processor bus 3110. On the other hand, by a write request from the processor 3100b allocated to the logical partition 3150b, writing to the memory mapped I/O area of the I/O slot 3140b is performed. The writing is also observed as a writing transaction 3700 on the processor bus 3110.

Normally, writing to the memory mapped I/O area is observed as an I/O write transaction 3710 on the I/O bus. However, in the second embodiment, switching between the logical partition 3150a and the logical partition 3150b is performed to use the I/O slot 3410b. Therefore, at least one write transaction issued from the processor 3100a or processor 3100b becomes a write request toward the main memory 3300, not transferred toward the I/O bus 3400.

For example, suppose that the logical partition 3150a is now using the I/O slot 3410b. At this time, a write transaction 3700 issued from the processor 3100a belonging to the logical partition 3150a toward the memory mapped I/O area is observed as an I/O write transaction through the I/O bus 3400. On the other hand, a write transaction 3700 issued from the processor 3100b belonging to the logical partition 3150b toward the memory mapped I/O area becomes a write request to the logical main memory space 3310 on the main memory 3300.

Upon switching to the logical partition 3150b to use the I/O slot 3410b, a write transaction 3700 issued from the processor 3100b is observed as an I/O write transaction 3710. At this time, information about finishing using the I/O slot 3410b is entered into the I/O event table in the node controller 3200, as described in the first embodiment. By referring to the event type field of the I/O event table, the main storage control unit of the node controller 3200 can detect finishing using the I/O slot.

By thus switching between the logical partitions to use the I/O slot 3410b, the I/O slot can be shared.

1. A data processing system comprising processors, a main memory, I/O slots, and a node controller, wherein the processors, the main memory, and the I/O slots are interconnected via the node controller and divided into a plurality of partitions in which individual operating systems are run simultaneously,
said node controller including a logical partition arbitration unit which stores information as to whether each said logical partition is using one of said I/O slots and controls access from each said logical partition to an I/O slot by referring to said information thus stored.

2. The data processing system according to claim 1, wherein:
said node controller further includes:
a main memory monitoring unit which monitors for writing to an area associated with an I/O slot on said main memory by a write request from one of said logical partitions;
a main memory and I/O synchronization unit which performs synchronization between given information written to said area associated with the I/O slot and given information written to the I/O slot; and
an I/O monitoring unit which monitors for staring and finishing access to the I/O slots allocated to said logical partitions,
wherein said logical partition arbitration unit, upon a request for access to one of said I/O slots from one of said logical partitions, checks whether the one I/O slot is being used, and
wherein said main memory and I/O synchronization unit transfers the request from the one logical partition to the one I/O slot, if the one I/O slot is not being used.

3. The data processing system according to claim 2,
wherein logical main memory spaces allocated to said logical partitions are provided on said main memory,
wherein each said memory space includes a logical memory mapped I/O area corresponding to a physical memory mapped I/O area of one of said I/O slots,
wherein a request for access to an I/O slot allocated to a logical partition from the logical partition is executed by writing of the I/O access request into said logical memory mapped I/O area,
wherein said main memory monitoring unit checks whether writing of the I/O access request from said logical partition into said physical memory mapped I/O area occurs,
wherein said logical partition arbitration unit checks whether said I/O slot is being used upon the occurrence of writing of the I/O access request into said memory mapped I/O area,
wherein said I/O monitoring unit checks whether a notification of I/O process completion is issued from said I/O slot, and
wherein said main memory and I/O synchronization unit transfers the I/O access request from said logical partition from the logical memory mapped I/O area to said I/O slot, if said I/O slot is not being used, or
transfers the I/O completion result from the physical memory mapped I/O area of the I/O slot to the logical memory mapped I/O area, if the notification of I/O process completion is issued from said I/O slot.

4. The data processing system according to claim 3,
wherein said main memory monitoring unit notifies said logical partition arbitration unit of the I/O access request upon the detection of writing of the I/O access request to said logical memory mapped I/O area,
wherein said logical partition arbitration unit, upon receiving the notification of said I/O access request, notifies said main memory and I/O synchronization unit of an event to start using the I/O slot, if the I/O slot is not being used,
wherein said main memory and I/O synchronization unit, upon receiving the notification of the event to start using the I/O slot, transfers the I/O access request from said logical memory mapped I/O area to said physical memory mapped I/O area,
wherein said I/O monitoring unit, upon detecting an event to finish using the I/O slot, notifies said logical partition arbitration unit that the logical partition finishes using the I/O slot,
wherein said logical partition arbitration unit, upon receiving the notification of said finish, issues a directive to said main memory and I/O synchronization unit to transfer the I/O completion result from said physical memory mapped I/O area to said logical memory mapped I/O area and makes the logical partition finish using the I/O slot.

5. The data processing system according to claim 4, wherein:
said main memory and I/O synchronization unit translates a logical address included in the I/O access request that is transferred to said physical memory mapped I/O area into a physical address, and translates a physical address included in the I/O completion result that is transferred to said logical memory mapped I/O area into a logical address.

6. The data processing system according to claim 4, wherein:
upon receiving the notification of the event to start using the I/O slot, said main memory and I/O synchronization unit directly maps said logical memory mapped I/O area to said physical memory mapped I/O area of said I/O slot, and
when said logical partition finishes using the I/O slot, said main memory and I/O synchronization unit demaps said logical memory mapped I/O area from said physical memory mapped I/O area to a given area on said main memory.

7. The data processing system according to claim 4,
wherein at least one command block to which a request for I/O access to said I/O slot should be transferred is provided in the logical main memory space on said main memory,
wherein said I/O monitoring unit, upon detecting an I/O process completion by said I/O slot, notifies said main memory monitoring unit that the logical partition finishes using the I/O slot, and
wherein said main memory monitoring unit, upon receiving the notification of said I/O process completion, monitors for completion of processing of said command block, and, upon detecting the completion of processing of all command blocks, notifies said logical partition arbitration unit that the logical partition finishes using the I/O slot.

8. The data processing system according to claim 4, wherein:
said logical partition arbitration unit performs the following:
switching between said logical partitions to use said I/O slot at predetermined time intervals;
enqueuing an I/O access request from a logical partition during a time interval when said I/O slot is not accessible for the logical partition and/or an I/O completion notification to a logical partition during a time interval when said I/O slot is not accessible for the logical partition; and
dequeuing and processing the enqueued I/O access request and/or dequeuing and delivering the enqueued I/O completion notification to the logical partition when entering a time interval when the I/O slot is accessible for said logical partition.

9. The data processing system according to claim 3,
wherein a logical memory mapped I/O area corresponding to a physical memory mapped I/O area of said I/O slot is provided in said logical main memory space,
wherein said main memory monitoring unit notifies said logical partition arbitration unit of the I/O access request upon the detection of writing of the I/O access request to said logical memory mapped I/O area,
wherein said logical partition arbitration unit, upon receiving the notification of said I/O access request, notifies said main memory and I/O synchronization unit of an event to start using the I/O slot, if the I/O slot is not being used,
wherein said main memory and I/O synchronization unit, upon receiving the notification of the event to start using the I/O slot, transfers the I/O access request from said logical memory mapped I/O area to said physical memory mapped I/O area,
wherein said main memory and I/O synchronization unit converts a an I/O process completion by said I/O slot a completion status from said logical memory mapped I/O area to a request to read from said physical memory mapped I/O area and converts a read response from said physical memory mapped I/O area to a read response from said logical memory mapped I/O area, and
wherein said logical partition arbitration unit, upon detecting the read completion by receiving the read response from said physical memory mapped I/O area, issues a directive to said main memory and I/O synchronization unit to transfer the completion result from said physical memory mapped I/O area of the I/O slot to said logical memory mapped I/O area and makes the logical partition finish using the I/O slot.

10. The data processing system according to claim 9, wherein said main memory and I/O synchronization unit translates a logical address included in the I/O access request that is transferred to said physical memory mapped I/O area into a physical address.

11. The data processing system according to claim 1, comprising:
means for allocating one I/O slot to said plurality of logical partitions;
means for detecting that one of said logical partitions starts using said one I/O slot;
means for detecting that one of said logical partitions finishes using said one I/O slot.

12. The data processing system according to claim 11,
wherein said I/O slots are connected to an I/O bus,
wherein said logical partitions comprise first and second logical partitions to which one of said I/O slots is allocated,
wherein switching between said first and second logical partitions to use said one I/O slot is performed, and
wherein, when a write transaction issued from one processor included in said first logical partition to said one I/O slot is delivered as a write transaction on said I/O bus, a request for access to said one I/O slot from another processor included in said second logical partition becomes a write request to said main memory, and, on switching from said first logical partition to said second logical partition to use said one I/O slot, the write request to said main memory is delivered as a write transaction on the I/O bus.

13. A method for sharing an I/O slot in a data processing system comprising processors, a main memory, I/O slots, and a node controller, wherein the processors, the main memory, and the I/O slots are interconnected via the node controller and divided into a plurality of partitions in which individual operating systems are run simultaneously,
wherein logical main memory spaces allocated to said logical partitions are provided on said main memory, and
wherein each said memory space includes a logical memory mapped I/O area corresponding to a physical memory mapped I/O area of one of said I/O slots,
said method comprising:
executing a request for access to an I/O slot allocated to a logical partition from the logical partition by writing the I/O access request into said logical memory mapped I/O area;
checking whether writing of the I/O access request from said logical partition into said physical memory mapped I/O area occurs;
if the I/O access request occurs, registering information indicating whether said I/O slot is being used into an I/O arbitration table;
upon the occurrence of writing of the I/O access request into said memory mapped I/O area, checking whether said I/O slot is being used by referring to said I/O arbitration table;
if said I/O slot is being used, enqueuing said I/O access request;
if said I/O slot is not being used, changing the I/O slot information in said I/O arbitration table to indicate that the I/O slot is being used; and
transferring the I/O access request from said logical memory mapped I/O area to said physical memory mapped I/O area.

14. The method for sharing an I/O slot according to claim 13, further comprising translating a logical address included in the I/O access request that is transferred to said physical memory mapped I/O area into a physical address.

15. The method for sharing an I/O slot according to claim 13, further comprising:
monitoring for an I/O process completion by said I/O slot;
upon detecting an I/O process completion by said I/O slot, transferring the I/O completion result from the physical memory mapped I/O area of said I/O slot to said logical memory mapped I/O area;
changing the I/O slot information in said I/O arbitration table to indicate that none is using the I/O slot; and
if there is an enqueued I/O access, transferring the I/O access to said I/O slot.

16. The method for sharing an I/O slot according to claim 15, further comprising translating a physical address included in the I/O completion result that is transferred to said logical memory mapped I/O area into a logical address.

17. The method for sharing an I/O slot according to claim 13, further comprising:
preparing at least one command block to which a request for I/O access to said I/O slot should be transferred in the logical main memory space on said main memory,
monitoring for an I/O process completion by said I/O slot;
issuing a directive to transfer the I/O completion result from the physical memory mapped I/O area of said I/O slot to said logical memory mapped I/O area;
checking whether all command blocks are completed,
if all command blocks are competed, changing the I/O slot information in said I/O arbitration table to indicate that none is using the I/O slot;
notifying said logical partition of the I/O process completion;
checking whether there is an enqueued I/O access request; and
if there is an enqueued I/O access request, transferring the I/O access request to said I/O slot.

18. The method for sharing an I/O slot according to claim 17, further comprising translating a physical address included in the I/O completion result that is transferred to said logical memory mapped I/O area into a logical address.

19. The method for sharing an I/O slot according to claim 13, further comprising:
monitoring for a read request to said logical memory mapped I/O area;
upon detecting the read request, converting the read request to said logical memory mapped I/O area to a read request to the physical memory mapped I/O area of the I/O slot;
awaiting a response to the read request issued to the physical memory mapped I/O area of said I/O slot;
upon receiving said response, converting the response to a response to the read request to the logical memory mapped I/O area for said logical partition;
checking whether said response indicates completion;
if the response indicates completion, changing the I/O slot information in said I/O arbitration table to indicate that none is using the I/O slot;
checking whether there is an enqueued I/O access request; and
if there is an enqueued I/O access request, transferring the I/O access request to said I/O slot.

20. The method for sharing an I/O slot according to claim 13, further comprising:
after transferring the I/O access request to said physical memory mapped I/O area to the physical memory mapped I/O area of said I/O slot, directly mapping said logical memory mapped I/O area to said physical memory mapped I/O area.

21. The method for sharing an I/O slot according to claim 20, further comprising:
monitoring for an I/O process completion form the I/O slot;
upon receiving the I/O process completion, demapping said logical memory mapped I/O area for said logical partition from the physical memory mapped I/O area;
transferring the completion result form the physical memory mapped I/O area of said I/O slot to said logical memory mapped I/O area;
changing the I/O slot information in said I/O arbitration table to indicate that none is using the I/O slot;
notifying said logical partition of the I/O process completion;
checking whether there is an enqueued I/O access request; and
if there is an enqueued I/O access request, transferring the I/O access request to said I/O slot.

22. The method for sharing an I/O slot according to claim 21, further comprising translating a physical address included in the I/O completion result that is transferred to said logical memory mapped I/O area into a logical address.

23. A method for sharing an I/O slot in a data processing system comprising processors, a main memory, I/O slots, and a node controller, wherein the processors, the main memory, and the I/O slots are interconnected via the node controller and divided into a plurality of partitions in which individual operating systems are run simultaneously, said method comprising:
executing a request for access to an I/O slot allocated to a logical partition from the logical partition by writing the I/O access request into a logical memory mapped I/O area corresponding to a physical memory mapped I/O area of the I/O slot, provided in a logical main memory space allocated to said logical partition on said main memory;
selecting one logical partition to use said I/O slot;
checking whether an I/O process completion interrupt for an I/O request from the selected logical partition is enqueued;
if there is an enqueued I/O process completion interrupt, notifying said logical partition of the I/O process completion interrupt;
checking whether an I/O access request from the selected logical partition is enqueued;
if there is an enqueued I/O access request, transferring the I/O access request form said logical memory mapped I/O area to said physical memory mapped I/O area;
enqueuing a request for I/O access to said I/O slot from a deselected logical partition;
enqueuing an I/O process completion interrupt to the deselected logical partition from said I/O slot;
after the elapse of a predetermined time, stopping the selected logical partition from using the I/O slot and selecting another logical partition.
